(19) United States
(12) Patent Application Publication
(10) Pub. No.: US 2024/0249583 A1
(43) Pub. Date: Jul. 25, 2024

(54) CHOKE DEVICE AND AN ASSEMBLY TO SUPPLY A GRANULAR OR POWDER PRODUCT PROVIDED WITH THE CHOKE DEVICE, IN PARTICULAR FOR AN AUTOMATIC BEVERAGE VENDING MACHINE

(71) Applicant: RHEAVENDORS INDUSTRIES S.P.A., Como (IT)

(72) Inventors: Fabio BRUZZESE, Como (IT); Claudio MAGGIONI, Como (IT); Roberto RIVA, Como (IT); Gianluca PIATTI, Como (IT); Carlo MOLINATI, Como (IT); Claudio BELTRAME, Como (IT)

(21) Appl. No.: 18/560,161

(22) PCT Filed: May 10, 2022
(86) PCT No.: PCT/IB2022/054314

§ 371 Date: Nov. 10, 2023

(30) Foreign Application Priority Data
May 10, 2021 (IT) 102021000011915

(51) Int. Cl. G07F 13/06; F16K 7/06; G07F 13/10

(52) U.S. Cl. CPC G07F 13/065; F16K 7/068; G07F 13/10

(57) ABSTRACT

In an automatic beverage vending machine, a feed assembly for feeding a granular or powder product has a feed duct for feeding the granular or powder product and a choke device configured to receive and choke at least partially an elastically deformable discharge section of the feed duct; the choke device comprising a fixed attachment frame, a choke member and a motorized movement assembly for moving the choke member between a support position, in which it maintains the discharge section in a product feed condition, and an overturned position, in which it elastically deforms and chokes at least partially the discharge section.

### CROSS-REFERENCE TO RELATED APPLICATIONS

This patent application claims priority from Italian patent application no. 102021000011915 filed on May 10, 2021, the entire disclosure of which is incorporated herein by reference.

### TECHNICAL FIELD OF THE INVENTION

The present invention relates to a choke device and to a feed assembly for a granular or powder product provided with such a device.

In particular, the present invention finds advantageous but not exclusive application in the feeding of a granular or powder product in an automatic beverage vending machine, to which the following discussion will make explicit reference without thereby losing generality.

Here and hereinafter, the term “product” means any soluble or partially soluble or hygroscopic material or any mixture of materials having any particle size and organoleptic properties to be preserved and maintained during their feeding.

### STATE OF THE ART

As is well known, automatic beverage vending machines are normally connected to the water supply network and generally comprise tanks containing granular or powder products and feed assemblies for feeding the aforementioned products.

An example of such feed assemblies is the one associated with an espresso brewing assembly for feeding sugar or other sweetener product into the coffee cup.

Regardless of the material dispensed, most of the known feed assemblies comprise a conveying pipe, which has its own product discharge section ending above the beverage container.

Although they are universally used, many of the known feed assemblies of the type defined above suffer from the main drawback of being poorly efficient and reliable.

The foregoing is due to the fact that the known assemblies do not allow the dosage of the fed product to be kept constant over time, in some cases, and they are not able to maintain the chemical-physical and/or organoleptic characteristics of the fed products unchanged, on the other hand.

As a result of tests and experiments, the Applicant was able to establish that the above-mentioned problems are essentially the result of the fact that the discharge section of the duct flows into an environment in which humid vapours, i.e. containing more or less fine water particles in suspension, are present.

These humid vapours inevitably, and especially when they are hot vapours, penetrate into the discharge section of the duct and gradually ascend the duct itself, lapping the internal walls of the duct until reaching the product dosing valve, if any.

With each dispensing, the internal walls of the duct progressively retain, firstly, the more volatile parts and, then, also the less volatile ones of the vapours with the consequence that the passage section of the duct is progressively reduced creating resistances to the feeding of the product. The resistances grow with each dispensing to the point in which they constitute a real obstacle to the feeding of the product, the dosage of which therefore varies uncontrollably.

The powderier the product and the more humidity-sensitive its organoleptic qualities, the more serious the problem becomes.

For this reason, known vending machines must undergo periodic check, cleaning and sanitization interventions. Each intervention entails inevitable costs and continuous machine downtimes and service interruption.

Attempts to close the outlet opening of the duct using external closure plates or plugs have proved ineffective in some cases and insufficiently reliable as well as complicated and expensive in others.

US2017119199 describes a feed device for feeding a granular product, wherein an elastically deformable intermediate section of a feed tube is choked by a thrust head moving orthogonally to the tube between two extreme end positions.

Document GB1012565D2 describes a liquid control valve, which is preferred for application in the field of washing machines or dishwashers for dosing the cleaning liquid by chocking the liquid delivery tube by overturning a part of the same delivery tube arranged upstream of the outlet section.

### SUBJECT AND SUMMARY OF THE INVENTION

Aim of the present invention is to realize a choke device, particularly for an automatic beverage vending machine, which allows the problem exposed above to be solved in a simple, efficient and economical way.

According to the present invention, a choke assembly device is realized as claimed in Claim 1.

The present invention also relates to a feed assembly for feeding a granular or powder product, particularly for an automatic beverage vending machine.

According to the present invention a feed assembly for feeding a granular or powder product as claimed in Claim 9 is realized.

The present invention finally relates to a feed method for feeding a granular or powder product into a container, particularly a container of an automatic beverage vending machine.

According to the present invention, there is provided a feed method for feeding a granular or powder product into a container as claimed in Claim 15.

### BRIEF DESCRIPTION OF THE DRAWINGS

FIG. 1 is a perspective view, with parts removed for clarity's sake, of an automatic beverage vending machine provided with a choke device and with a feed assembly for feeding a granular or powder product, all realized according to the dictates of the present invention.

FIGS. 2 and 3 show, in perspective view and on an enlarged scale, the choke device of FIG. 1 arranged in two different functional conditions.

FIGS. 4 and 5 are plan views of the choke device of FIG. 2 and, respectively, of FIG. 3.

FIG. 6 is an enlarged scaled section according to line VI-VI of FIG. 4.

FIG. 7 is an enlarged scaled section according to line VII-VII of FIG. 5.

### DETAILED DESCRIPTION OF PREFERRED EMBODIMENTS OF THE INVENTION

The present invention will now be described in detail with reference to the accompanying figures to allow a skilled person to make and use it. Various modifications of the embodiment described will be immediately clear to the skilled person and the general principles disclosed can be applied to other embodiments and applications without departing from the protection scope of the present invention, as defined in the enclosed drawings. Therefore, the present invention shall not be limited to the shown and described embodiments, but it must be granted the widest protection scope in accordance with the features disclosed and claimed.

Unless otherwise defined, all the herein used technical and scientific terms have the same meaning commonly used by the ordinary skilled in the art of the present invention. In case of conflict, the present invention, including definitions provided, will be binding. Furthermore, the examples are provided for merely illustrative purposes and must not be regarded as limiting.

In order to ease the understanding of the herein described embodiments, reference will be made to some specific embodiments and a specific language will be used to describe them. The terminology used in the present document aims at describing only particular implementations, and is not intended to limit the scope of the present invention.

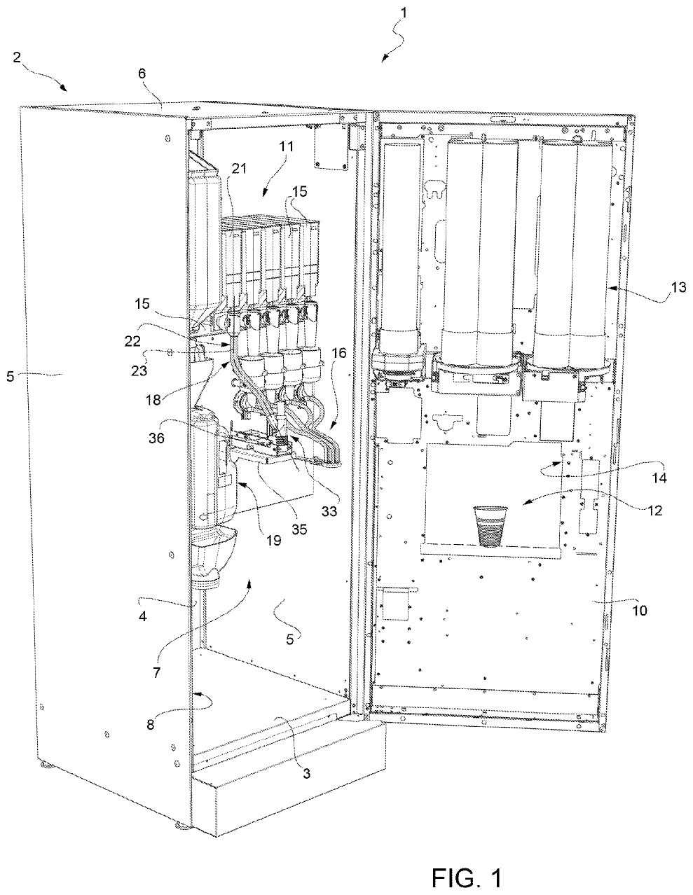

In FIG. 1, reference number 1 denotes an automatic beverage vending machine as a whole.

The vending machine 1 comprises an external casing or container 2, in turn, comprising, a floor support base 3, a rear wall 4, two side walls 5 and an upper wall 6 facing the support base 3.

The support base 3 and the side 5 and upper 6 walls delimit a chamber 7 which is accessed through a front or anterior opening 8 facing the rear wall and closed by a hinged door 10.

Within the chamber 7, the container 1 houses a plurality of assemblies 11 for preparing beverages in general and dispensing the same beverages into cups 12 (only one of which is visible in FIG. 1) distributed by distributing assemblies 13, per se known and configured to feed the cups 12 into a compartment 14 outside the door 10.

Each assembly 11 comprises a relative storage tank 15 for a granular or powder material which is arranged resting on a shelf 15 that is adjacent to the upper wall 6 and ducts 16 for dispensing a beverage or relative product into the cup 12 housed in the compartment 14.

Again with reference to FIG. 1, the vending machine 1 also comprises a feed assembly 18 for feeding a granular or powder product.

In the example described, the assembly 18 is associated with an assembly 19 for the preparation and distribution of espresso coffee, which is also per se known and not described in detail. In this case, the assembly 18 feeds a mass of granular or powder sweetener product. e.g. sugar, directly into the cup 12.

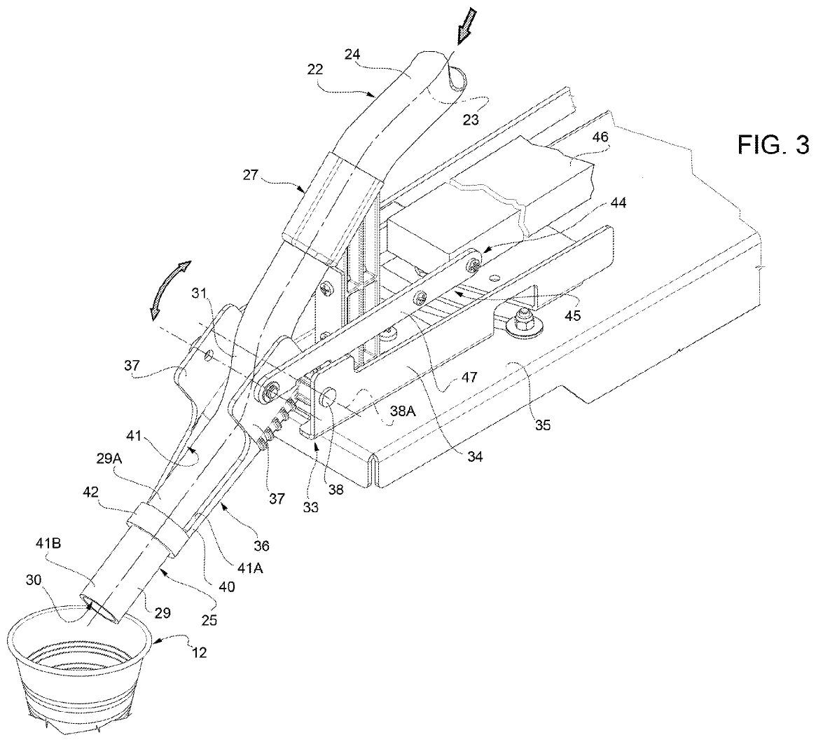

In the example described, the assembly 18 comprises, a sweetener product storage tank 21 which rests on the shelf 15 and a feed duct 22 to guide the product towards the cup 12 along a feed path 23 (FIGS. 1 and 3).

The duct 23 comprises an inlet section 24 configured, in a per se known manner, to receive the sweetener product from the tank 21 and a discharge section 25 for discharging the product into the cup 12.

Preferably, the discharge section 25 is connected in a disconnectable manner to the inlet section 24 by means of a releasable joint 27, which is per se known and, conveniently, of the sliding engagement type.

Preferably, the discharge section 25 is made entirely of elastomeric material and therefore of elastically deformable material and comprises a portion 28 joining the inlet section 24, a terminal portion 29 delimiting an outlet opening 30 for the sweetener product, and an intermediate portion 31.

Alternatively, according to a variant not shown, only the intermediate portion 31 is made of elastically deformable material, while the joining portion 28 and the terminal portion 29 may be made of different materials or be substantially rigid tubular portions.

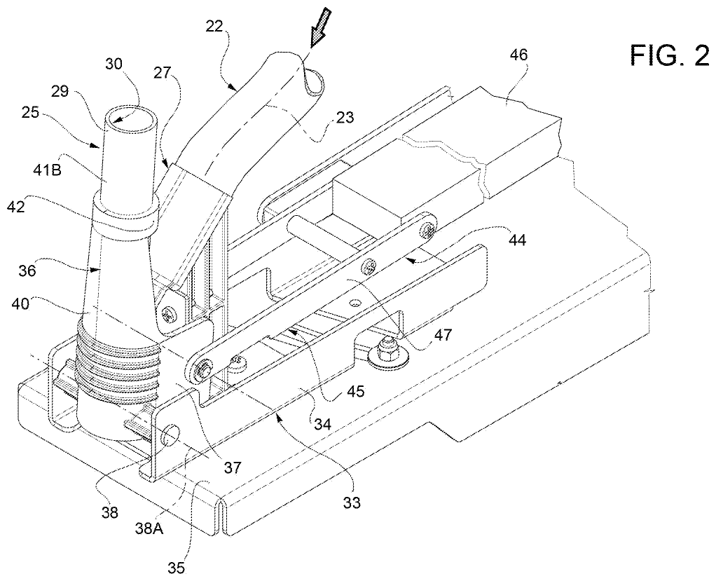

Still with reference to FIG. 1 and, in particular, FIGS. 2 and 3, the assembly 18 further comprises a choke device 33 to elastically deform the intermediate portion 31 and at least partially choke the discharge section 25, as will be evident from the following.

The choke device 33 comprises its own frame 34, which is arranged resting on a shelf 35 fixed to the container 2.

Conveniently, the frame 34 is releasably connected to the shelf 35 by means of screws or other releasable attachment devices so that it can be easily removed and replaced by opening the door 10.

The choke device 33 then comprises a choke member 36, in turn, comprising a rear attachment portion 37, which is U-shaped and crossed by the intermediate portion 31. The rear portion 37 is hinged to the frame 34 by means of a hinge pin 38 arranged orthogonally to the path 23 and below the path 23 itself and the intermediate portion 31.

The choke member 36 then comprises an anterior support portion 40, which is shaped to delimit a recess 41, into which a rear section 29A of the terminal portion 29 extends. The rear section 29A perpetually rests on a back wall 41A of the recess 41 and is retained in the recess 41 by a collar 42.

An anterior section 41B of the same terminal portion 29 protrudes, however, in a cantilever fashion beyond the choke member 36.

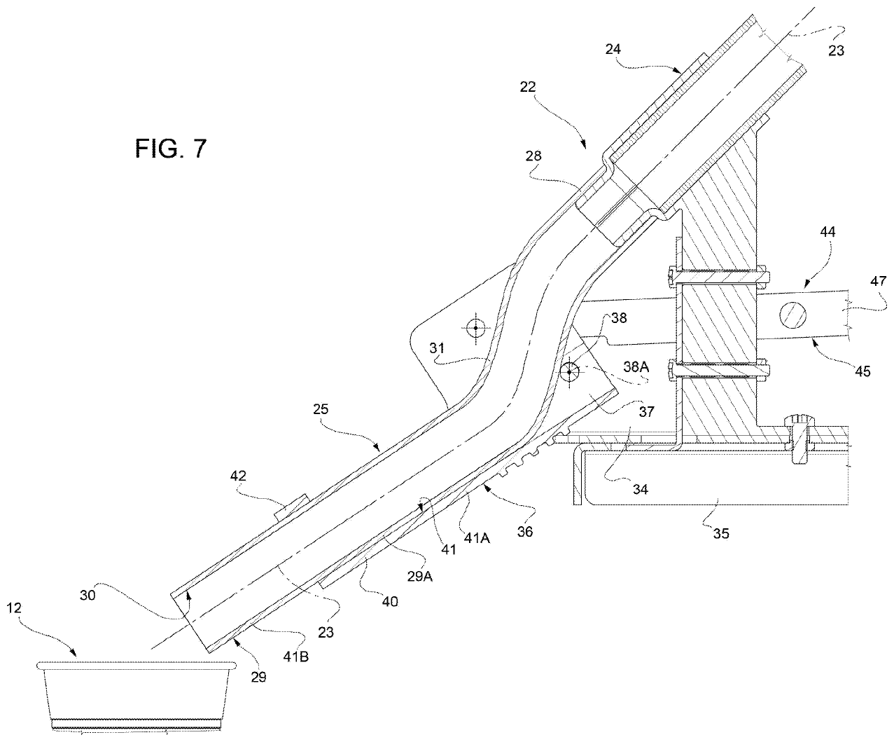

The back wall 41A extends in a position spaced away from the pin 38 (FIGS. 5 and 7).

The choke member 36 is rotatable with respect to the frame 34 and about a fixed hinge axis 38A defined by the pin 38 under the thrust of a motorized actuator device 44, to rotate between a support position, in which it maintains the terminal portion 29 in a condition of feeding the product into the cup 12, shown in FIGS. 3, 5 and 7, and a position that is overturned backwards with respect to the support position, shown in FIGS. 2, 4 and 6, in which it elastically bends and deforms the intermediate portion 31 and chokes the intermediate portion 31 itself by pushing it into contact with the wall 41A, effectively fluid-tightly isolating the inlet duct 24 and part of the discharge duct 25 from the outside.

Alternatively, according to a variant not shown, the choke member 36 chokes the intermediate portion 31 without, however, completely occluding the passage so that the inlet section 24 is not mechanically isolated from the outside in a fluid-tight fashion.

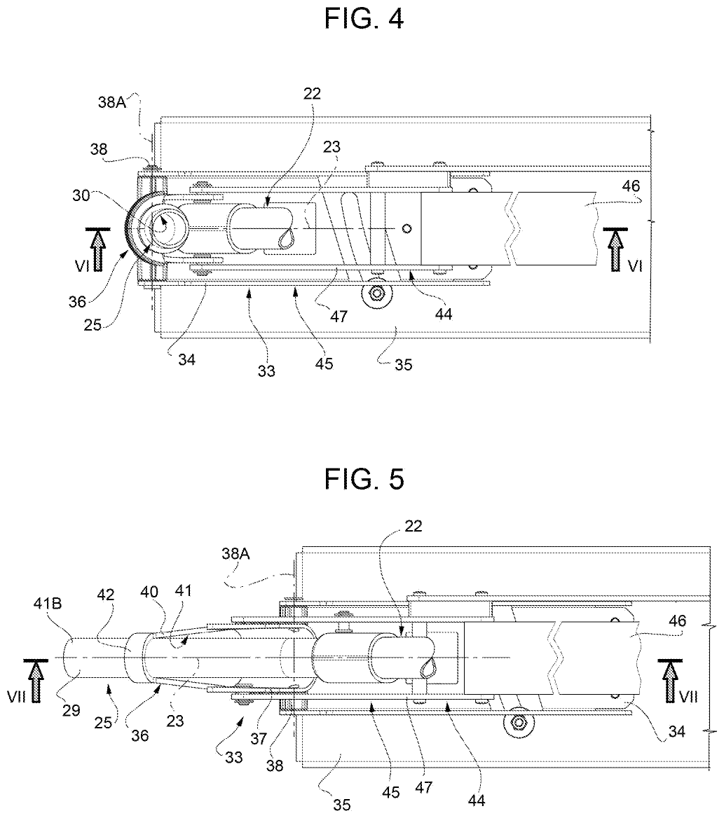

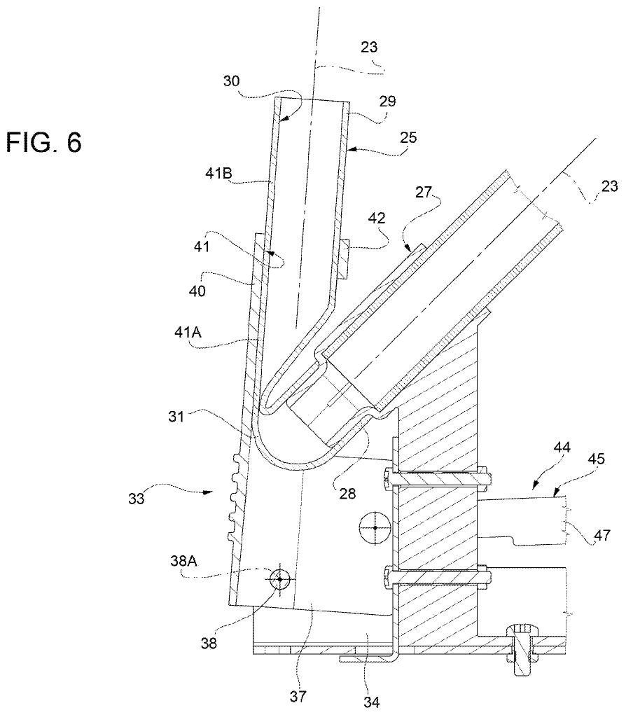

As can be seen from FIGS. 2 and 4 and, in particular, FIG. 6, when the choke member 36 is arranged in its overturned position, the back surface 41A of the recess 41 extends in a substantially vertical position, the terminal portion 29 extends upwards by arranging its outlet 30 facing upwards in the direction opposite to the cup 12.

Referring again to FIGS. 2 and 3, the motorized actuator 44 comprises a connecting rod-crank transmission 45 and an electric motor 46 for operating the connecting rod-crank transmission 45.

Conveniently, the transmission 45 comprises a connecting rod defined by a fork 47 having arms arranged on opposite parts of the rear attachment portion 37 and pivoted on the rear portion 37, and a pair of connecting rods defined by parts of the rear portion 37 itself.

From the foregoing, it is evident that the choke device 33 described prevents vapours or sprays of the beverage and, in general, all volatile substances at temperature and not present in the discharge area of the sweetener product, i.e. in or around the compartment 14, from penetrating into the feed duct 18 through the opening 30 both before and after the dispensing of the product by spraying or simply humidifying the internal surface of the same feed duct.

The foregoing is due to the fact that a portion of the duct 18 close to the outlet is choked and compressed until its passage section is nullified, thereby fluidically isolating the feed duct from the outside.

In addition to this, the backward overturning of the terminal portion 29 results in a distancing of the outlet opening 30 from the dispensing area and the upward orientation of the same outlet opening 30 further hindering and, in practice, preventing the entry into the terminal section 18 of vapours or substances present in the dispensing area.

In this way, the environment inside the duct 18 is kept dry and clean, preventing, on the one hand, parts of the fed product, including the most powdery ones, from adhering to the internal surface of the duct and crystallising, thus creating roughness or obstacles to the free feeding of the product and, on the other hand, variations in the expected chemical, physical and organoleptic characteristics of the same product necessary to perform a predefined sweetening from occurring.

Experimentally, it was then possible to ascertain that the maintenance of a substantially anhydrous condition of the internal volume of the duct 18 is maintained, in some cases, even without completely occluding the intermediate portion, but simply chocking it also being the outlet opening 30 oriented on the other side of the cup 12 and, in general, arranged in an area “away” from the product feeding area when the choke member 36 is arranged in its overturned position. The degree of chocking is variable, for example, depending on the cross-section of the duct, the sensitivity of the product to humidity and the aggressiveness of the humid or contaminated vapours.

From the foregoing, it is also evident that the described feed assembly 18 operates independently of the type and characteristics of the product to be fed.

For this reason, it is evident that the feed assembly 18 described can be associated not only with any beverage preparation assembly provided inside the automatic beverage vending machine 1 but it can be used in all those cases in which, regardless of the container provided to receive it, the product is dispensed in an environment in which vapours or volatile substances are present or sprays can be generated which can enter the duct through the outlet and compromise not only the efficiency and functional reliability of the feed assembly but also modify both the chemical-physical characteristics of the product and its organoleptic qualities.

The fact of providing a releasable joint between the discharge section 25 and the inlet section 24 facilitates and speeds up the maintenance and/or replacement operations of the elastically deformable section, i.e. of that section which, according to the foregoing, is subject to high fatigue cycles and therefore to deterioration and wear, leaving the remaining part of the duct 18 unaltered.

Moreover, the replacement of the discharge section 25 is possible by simply removing the same discharge section 25 from the choke device 36, therefore without any special technical knowledge and without the use of specific or dedicated tools, the use of which is always undesirable, especially in automatic beverage vending machines where there is very little room for manoeuvre.

Finally, the fact that the feed assembly 18 comprises its own attachment frame 34 and that it can be connected to a fixed support structure by means of simple screws or other equivalent releasable connecting systems, as well as the presence of the joint 27, allow the entire device 33 to be removed and replaced easily and in a very short time.

From the foregoing, it is also evident that changes and variations can be made to the described assembly 18 without thereby leaving the protective scope defined by the independent claims. In particular, the choke member 36 could be coupled to the frame 34 in a manner other than that described to move along paths other than the one indicated, as well as it could be moved by a drive assembly without mechanical lever transmissions using, for example, an electric linear motor, or transmissions of the nut screw-screw type.

Not only that, but the choke member 36 and/or its attachment to the frame 34 could be modified to bring the intermediate portion 31 as close as possible to the outlet opening 30.

1-16. (canceled)

17. A feed assembly for feeding a granular or powder product for an automatic beverage vending machine, the assembly comprising a feed duct for feeding said granular or powder product to guide the product along a feed path and towards a product discharge container, the duct having a discharge section delimiting a product outlet opening towards the container, the discharge section comprising at least one intermediate portion made of elastically deformable material and a terminal portion delimiting said outlet opening; the assembly furthermore comprising a choke device configured to receive said discharge section and comprising: an attachment frame designed to be connected to a fixed support; a choke member coupled to said attachment frame and having a support surface for said discharge section; and motorized means for moving said choke member with respect to said attachment frame between a support position, in which it maintains the discharge section in a product feed condition, and an overturned position, in which said support surface extends in a substantially vertical position to elastically deform and at least partially choke said intermediate portion and said discharge section upstream of said outlet opening in the product feed direction along said feed path, and maintains said outlet opening facing upwards;
when the choke member is arranged in its overturned position, said terminal portion being overturned backwards with respect to the feed position and said outlet opening facing upwards.

18. The assembly according to claim 17, wherein, when said choke member is arranged in its overturned position, said intermediate portion is compressed against the support surface and occluded and the discharge section is closed in a fluid-tight manner.

19. The assembly according to claim 17, wherein said choke member is rotatable in opposite directions about a hinge axis orthogonal to said feed path.

20. The assembly according to claim 19, wherein said hinge axis extends below said feed path.

21. The assembly according to claim 17, wherein said duct comprises a product inlet section, and wherein a releasable connection joint is interposed between said inlet section and said discharge section.

22. The assembly according to claim 17, furthermore comprising hinge means interposed between said choke member and said frame to allow the choke member to rotate around at least one hinge axis.

23. The assembly according to claim 22, wherein said hinge axis is an axis fixed with respect to said frame.

24. The assembly according to claim 22, wherein said hinge axis extends below said intermediate portion.

25. The assembly according to claim 17, wherein said choke member is hinged to said frame by means of a single fixed hinge pin and protrudes in a cantilever fashion from the frame.

26. The assembly according to claim 17, wherein said choke member comprises a recessed portion at least partially housing a terminal portion of said discharge section and retention means for retaining said terminal portion in said recessed portion; a back wall of said recessed portion defining said support surface.

27. The assembly according to claim 17, wherein said motorized means comprise a connecting rod-crank transmission and an electric actuator for operating said connecting rod-crank device.

28. The assembly according to claim 27, wherein said connecting rod-crank transmission comprises a connecting rod defined by a fork having arms arranged on opposite sides of said choke member.

29. An automatic beverage vending machine comprising a storage tank for a granular or powder product and a product feed assembly according to claim 17; wherein the inlet section is configured to receive the product from said storage tank and convey it into said discharge section.

30. A feed method for feeding a granular or powder product into a container, particularly a cup in an automatic beverage vending machine; the method comprises the step of feeding the product towards the container using a feed duct having an inlet section configured to receive the granular or powder product and a discharge section having a terminal portion delimiting a product outlet opening, the step of forming the discharge section providing at least one intermediate portion of said discharge section made of elastically deformable material, the step of elastically deforming the intermediate portion thus choking at least partially the discharge section upstream of said outlet opening in a product feed direction after a dosed product mass has been fed into said container and wherein the deformation and the choking of said intermediate portion is carried out by overturning backwards the terminal portion of said discharge section until said outlet opening is facing upwards.

31. The method according to claim 30, wherein the deformation and the choking of said intermediate portion is carried out so as to compress said intermediate portion and close in a fluid-tight manner the part of said duct arranged upstream of said intermediate portion.
